(19) United States
(12) Patent Application Publication
(10) Pub. No.: US 2019/0226376 A1
(43) Pub. Date: Jul. 25, 2019

(54) Controller for Determining the Injected Volume of a Fluid in an Injection System of a Motor Vehicle

(71) Applicant: Continental Automotive GmbH, Hannover (DE)

(72) Inventors: Danica Siedenberg, Regensburg (DE); Martin Brandt, Wörth a.d. Donau (DE); Axel Burkhardt, Wiesent (DE); Xaver Gebhardt, Kelheim (DE); Anatoliy Lyubar, Wolfsegg (DE); Hong Zhang, Tegernheim (DE)

(73) Assignee: Continental Automotive GmbH, Hannover (DE)

(21) Appl. No.: 16/315,040

(22) PCT Filed: Jun. 26, 2017
(86) PCT No.: PCT/EP2017/065744

§ 371 Date: Jan. 3, 2019

(30) Foreign Application Priority Data
Jul. 5, 2016 (DE) 10 2016 212 263.0

(51) Int. Cl. F01N 3/20; F02D 41/38

(52) U.S. Cl. CPC F01N 3/208; F02D 41/3809; F01N 2550/05; F02D 2041/224; F01N 2610/144; F01N 2900/1808; F01N 2560/08

(57) ABSTRACT

Various embodiments may include a method for controlling an injection process in which a fluid is conveyed to an injection element through a line system comprising: determining a time of a maximum pressure gradient caused by the injection process, based on output signals of a first pressure sensor; calculating a difference between the maximum pressure gradient and a start time; determining a propagation speed of the fluid in the line system based on the difference; determining a rigidity of the line system based on the propagation speed; determining an injected volume of the fluid based on the determined rigidity of the line system; and controlling the injection process based on the injected volume determined.

### CROSS-REFERENCE TO RELATED APPLICATIONS

This application is a U.S. National Stage Application of International Application No. PCT/EP2017/065744 filed Jun. 26, 2017, which designates the United States of America, and claims priority to DE Application No. 10 2016 212 263.0 filed Jul. 5, 2016, the contents of which are hereby incorporated by reference in their entirety.

### TECHNICAL FIELD

The present disclosure relates to motor vehicles. Various embodiments of the teachings herein may include a method and/or a device for determining the injected volume of a fluid in an injection system of a motor vehicle.

### BACKGROUND

An important parameter for the determination of the target fuel injection volume in a motor vehicle is the requested torque. This requested torque is dependent on the driver's request and is determined by a sensor whose output signals contain information about the instantaneous position of the accelerator pedal. Further important parameters for the determination of the target fuel injection volume are, for example, the instantaneous rotational speed, the instantaneous velocity, the instantaneous engine load and the instantaneous engine temperature. The determination of the target fuel injection volume is carried out by means of a control unit to which information about the above-mentioned parameters and about further parameters is fed.

During the operation of the motor vehicle it is important to obtain information about what fuel volume has actually been injected within the scope of an injection process. In what are referred to as SCR catalytic converter systems and MPI injection systems (multi-point injection systems) it is important to obtain information about what fuel volume has actually been injected within the scope of an injection process.

### SUMMARY

The teachings of the present disclosure may be used to specify an improved method and an improved device for determining the injected volume of a fluid in an injection system of a motor vehicle. For example, some embodiments may include a method for determining the injected volume of a fluid in an injection process carried out by means of an injection system of a motor vehicle, in which the fluid is conveyed to an injection element through a line system, having the following steps: determining the time (t2) of occurrence of the maximum of the pressure gradient caused by the injection process, using the output signals (p2) of a first pressure sensor (S2), forming a time difference (Δt) between the time (t2) of occurrence of the maximum of the pressure gradient caused by the injection process and the time (t1) of the start of the injection process, determining the propagation speed (c) of the fluid in the line system using the formed time difference (Δt), determining the rigidity (E_{system}) of the line system using the propagation speed (c) and determining the injected volume (Vᵢₙⱼ) of the fluid using the determined rigidity (E_{system}) of the line system.

In some embodiments, the time (t1) of the start of the injection process is predefined by a control unit (4).

In some embodiments, the time (t1) of the start of the injection process is determined using the output signals of a second pressure sensor (S1)

In some embodiments, the injected fuel mass (mᵢₙⱼ) is determined using the injected fluid volume (Vᵢₙⱼ) and the density (ρ) of the fluid.

In some embodiments, the propagation speed (C) of the fluid in the line system is determined according to the following relationship:

c=l/Δt,
wherein c is the propagation speed, l is the length of the line system and Δt is the time difference between the time of the start of the injection process and the time of occurrence of the maximum of the pressure gradient caused by the injection process.

In some embodiments, the natural frequency (f_{system}) of the line system is determined from the propagation speed (c) and the length (l) of the line system.

In some embodiments, the rigidity (E_{system}) of the line system is determined from the propagation speed (c) and the density (ρ) of the fluid.

In some embodiments, the density (ρ) of the fluid is obtained from a memory.

In some embodiments, a pressure difference (Δp) which is brought about by the injection process is determined.

In some embodiments, the injected volume (Vᵢₙⱼ) of the fluid is determined according to the following relationship:

Vᵢₙⱼ=(Vₜₒₜₐₗ·Δp)/E_{system},
wherein Vₜₒₜₐₗ is the total volume of the line system.

As another example, some embodiments include a device for determining the injected volume of a fluid in an injection process carried out by means of an injection system of a motor vehicle, in which the fluid is conveyed to an injection element through a line system, characterized in that said device has a control unit (4) which is designed to carry out a method as described above.

### BRIEF DESCRIPTION OF THE DRAWINGS

Further characteristics of the teachings herein and various embodiments thereof will emerge from the exemplary explanation thereof below on the basis of the figures. In the drawings:

FIG. 1 shows a block illustration of a device for determining the injected volume of a fluid in an injection system of a motor vehicle incorporating the teachings of the present disclosure;

FIG. 2 shows a diagram illustrating the pressure profile in the region of the start of the line, shown in FIG. 1, after the start of an injection process;

FIG. 3 shows a diagram illustrating the pressure profile in the region of the end of the line, shown in FIG. 1, after the start of an injection process;

FIG. 4 shows diagrams illustrating the determined injected fuel volume when a flexible line is present and when a steel line is present in a method incorporating the teachings of the present disclosure, and in a method based on a simulation, as a function of the proportion of air of the fluid; and

FIG. 5 shows diagrams illustrating the rigidity as a function of the proportion of air in the fluid when a flexible line is present and when a steel line is present.

### DETAILED DESCRIPTION

In some methods incorporating the teachings of the present disclosure for determining the injected volume of a fluid in an injection system of a motor vehicle, in which the fluid is conveyed to an injection element through a line system, the time of occurrence of the maximum of the pressure gradient caused by the injection process is determined using the output signals of a first pressure sensor, a time difference between the time of occurrence of the maximum of the pressure gradient caused by the injection process and the time of the start of the injection process is formed, the propagation speed of the fluid in the line system is determined using the formed time difference, the rigidity of the line system is determined using the propagation speed, and the injected volume of the fluid is determined using the determined rigidity of the line system. This ensures that the overall rigidity of the line system which changes during operation, for example as result of temperature changes or changes of the air content in the system, is taken into account during the determination of the injected fluid volume. As a result, during operation of the injection system, the control unit can take into account the instantaneous overall rigidity of the line system during the subsequent determination of a new value for the target injection volume. This brings about improved adaptation of the target injection volume of a fluid, on the basis of an on-board diagnosis, to the instantaneous operating conditions of the motor vehicle, for example to the instantaneous driver's request.

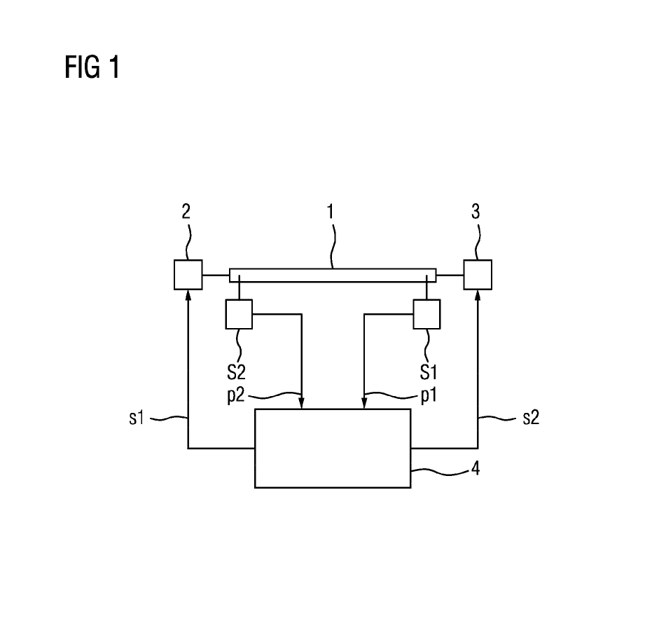

FIG. 1 shows a block illustration of a device for determining the injected volume of a fluid in an injection system of a motor vehicle. This injection system is, for example, an SCR catalytic converter injection system, in which a urea solution is supplied from a feed pump serving as a fluid source to an injection valve serving as a fluid sink, via a line system, by means of which injection system urea solution is injected into the exhaust gas train of the motor vehicle during operation. The illustrated device has, as a line system, a line 1 through which the urea solution which is made available by the feed pump 2 is fed to the injection valve 3. The feed pump 2 is actuated by a control unit 4 by means of a control signal s1, the injection valve 3 is actuated by means of a control signal s2.

Provided in the region of the end of the line of the line 1 is a pressure sensor S1, which is provided for measuring the pressure in the region of the end of the line and feeds an associated sensor signal p1 to the control unit 4. Provided in the region of the start of the line is a further pressure sensor S2, which is provided for measuring the pressure in the region of the start of the line and feeds an associated sensor signal p2 to the control unit 4.

The control unit 4 is designed to determine the above-mentioned control signals s1 for the fluid source 2 and s2 for the fluid sink 3, and furthermore, to determine the fluid volume Vᵢₙⱼ injected within the scope of an injection process, using a working program stored in a memory, the above-mentioned information about the pressure at the start of the line and at the end of the line, from information about further parameters of the vehicle, and using stored characteristic data.

In some embodiments, the determination of the fluid volume injected within the scope of an injection process is performed by means of the control unit 4 as follows:

In a first step ST1, the time t1 of the start of an injection process is acquired using the pressure signals p1 determined by the pressure sensor S1. As an alternative to this, this time t1 can also be made available by the control unit 4 which is designed to control the entire injection process.

After this, in a second step ST2 the time of occurrence of the maximum of the pressure gradient caused by the injection process is determined using pressure signals p2 determined by the pressure sensor S2. To this purpose, the control unit 4 forms difference signals from chronologically successive pressure signals p2, and determines the maximum of these difference signals, and the time t2 of occurrence of this maximum difference signal, which time t2 corresponds to the maximum pressure gradient in the inlet region of the line 1.

After this, in a step ST3 a time difference Δt is determined according to the following relationship:

Δt=t2−t1.

This time difference is the time difference between the time t2 of occurrence of the maximum of the pressure gradient caused by the injection process and the time t1 of the start of the injection process.

In a subsequent step ST4, the propagation speed c_{system} of the fluid in the line system is determined using the specified time difference Δt according to the following relationship:

c_{system}=l/Δt,

where l is the length of the line 1.

After this, if desired, in a step ST5 the natural frequency f_{System} is determined according to the following relationship:

f_{System}=c_{System}/2·l.

In a subsequent step ST6, the rigidity of the line system is determined as follows:

E_{System}·c_{System}²·ρ,

where ρ is the density of the fluid. This density of the fluid is obtained from a memory in which an associated density value is stored for each of a multiplicity of propagation speeds.

After this, in a step ST7 the pressure drop Δp caused by the injection process is determined as follows:

Δp=p1−p3,

where p3 is the pressure determined by means of the pressure sensor S2 in the region of the start of the line and after the decay of the pressure oscillation caused by the injection process. This decay of the pressure oscillation caused by the injection process has already taken place after the expiry of a short time period after the start of the injection process, with the result that during the operation of the system the determination of the injection volume can be performed a long time before the start of a subsequent injection process. Therefore, it is also possible to react quickly to possible deviations of the determined injection volume from the target injection volume, with the result that during subsequent injection processes the deviation of the actual injection volume from the target injection volume can be quickly reduced.

In a step ST8, the volume reduction of the fluid which is brought about by the injection process and which corresponds to the injection volume to be determined is determined from this pressure drop Δp, according to the following relationship:

Vᵢₙⱼ=ΔV_{System}=(Vₜₒₜₐₗ·ΔP)/E_{System},

where Vₜₒₜₐₗ is the total volume of the line system.

The injected mass mᵢₙⱼ of the fluid is finally determined in a step ST9 by means of the following relationship:

mᵢₙⱼ=Vᵢₙⱼ·ρ.

The method described by means of the above equations then permits the fluid volume Vᵢₙⱼ injected within the scope of an injection process to be determined using measured pressure signals at the start and end of the line, the knowledge of the start of the injection process and the density of the fluid, wherein the measured pressure values are used to form a time difference between the time of the start of an injection process and the time of occurrence of the maximum of the pressure gradient caused by the injection process. The formed time difference is used to determine the propagation speed of the fluid in the line system. The rigidity of the line system is determined using the propagation speed of the fluid in the line system. The injected volume of the fluid can finally be determined using the determined rigidity of the line system. Furthermore, the injected mass of fluid can be determined from the injected fluid volume using the density of the fluid. By means of this procedure, the rigidity of the line system which changes during the operation of the injection system, in particular owing to temperature fluctuations and also the air content in the line system, is taken into account during the determination of the injected fluid volume and can be taken into account for the generation of control signals for subsequent injection processes. The determination of the injected fluid volume can be carried out in a very short time, since all the information which is required for this determination is already available after the decay of the pressure oscillation caused by an injection process. Time intervals with respect to subsequent injection processes do not play any role during this procedure. The determination of the injected fluid volume can be performed during a single injection process as soon as the specified pressure oscillation caused by the injection process has decayed.

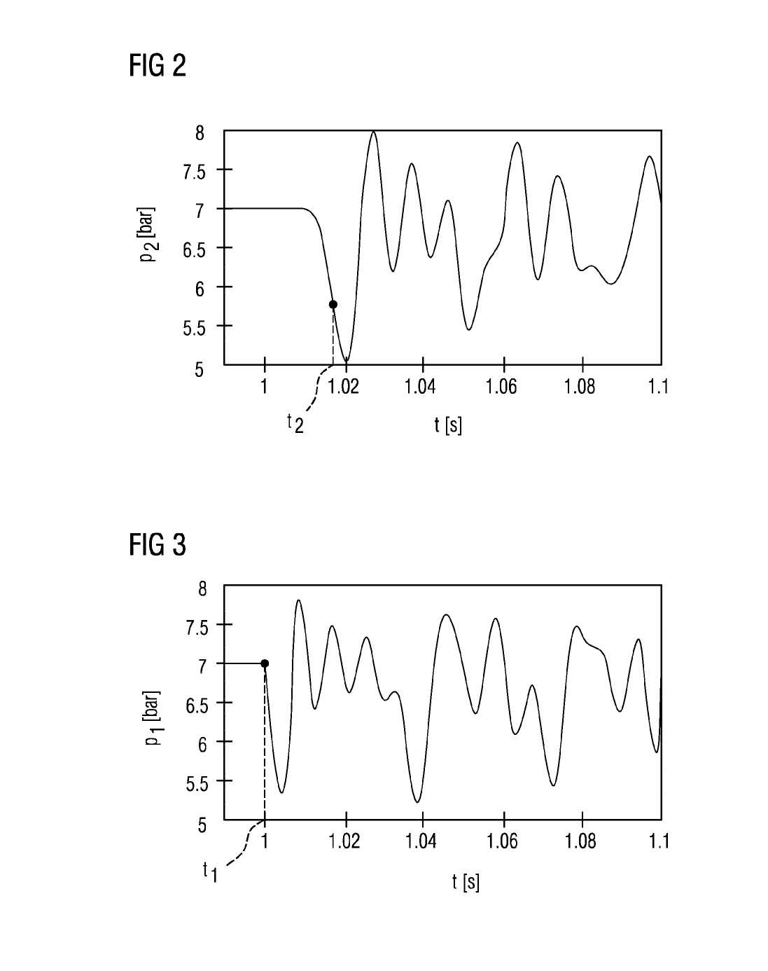

FIG. 2 shows a diagram illustrating the pressure profile in the region of the start of the line, shown in FIG. 1. In this diagram, the pressure p2 is plotted at the top in bar and the time is plotted on the right in seconds.

FIG. 3 shows a diagram illustrating the pressure profile in the region of the end of the line, shown in FIG. 1. In this diagram, the pressure p1 is plotted at the top in bar and the time is plotted on the right in seconds.

In the exemplary embodiment shown, a pressure with a level of in each case 7 bar as the initial state is present both in the region of the start of the line and in the region of the end of the line. Taking this initial state as a starting point, an injection process is triggered by the control unit 4 by virtue of the fact that the control unit 4 outputs a control signal s2, which opens the injection valve, to the injection valve 3 which is connected to the end of the line.

As a result, a pressure drop occurs in the region of the end of the line 1, which pressure drop is detected on the basis of the output signals of the pressure sensor S1 positioned in the region of the end of the line. A pressure profile such as is illustrated in FIG. 3 occurs in the region of the end of the line. The time t1 of the start of the injection process occurs as soon as a drop in the pressure starts, proceeding from the output state 7.

The pressure profile which arises in reaction to the start of the injection process, in the region of the start of the line 1, is illustrated in FIG. 2. Successive pressure values of this pressure profile are compared with one another in order to determine the time t2 of occurrence of the maximum of the pressure gradient caused by the injection process. This time t2 is characterized in FIG. 2.

The control unit 4 forms the time difference Δt between the time t2 of occurrence of the maximum of the pressure gradient caused by the injection process and the time t1 of the start of the injection process.

Δt=t2−t1.

Subsequently, the control unit 4 determines the propagation speed of the fuel in the line 1 using the specified time difference Δt. The following relationship applies:

c_{system}−l_{Pipe}/Δt.

l_{Pipe} is here the length of the line 1.

In the next step, the propagation speed is used to calculate the natural frequency of the system. This is done by means of the following relationship:

f_{System}−c_{System}/2·l_{Pipe}.

Furthermore, the specified propagation speed is used to determine the rigidity of the line 1. This is carried out by means of the following relationship:

E_{System}=c_{System}²·ρ.

ρ is here the density of the fuel.

Subsequently, the pressure difference caused by the injection process in the region of the start of the line is determined. This is done after the decay of the pressure oscillation caused by the injection process, already before the start of a subsequent injection process, by measuring a pressure p3 by means of the pressure sensor S2 and subsequently forming the difference between the pressure values p1 and p3:

Δp=p1−p3.

The specified pressure difference Δp and the determined rigidity E_{system} are used to determine the volume reduction which is brought about by the injection process and which corresponds to the injection volume to be determined:

Vᵢₙⱼ=ΔV_{System}=(Vₜₒₜₐₗ·Δp)/E_{System}.

The injection volume which is determined in this way and the density of the fuel are finally used to determine the injected fuel mass:

mᵢₙⱼ=Vᵢₙⱼ·ρ.

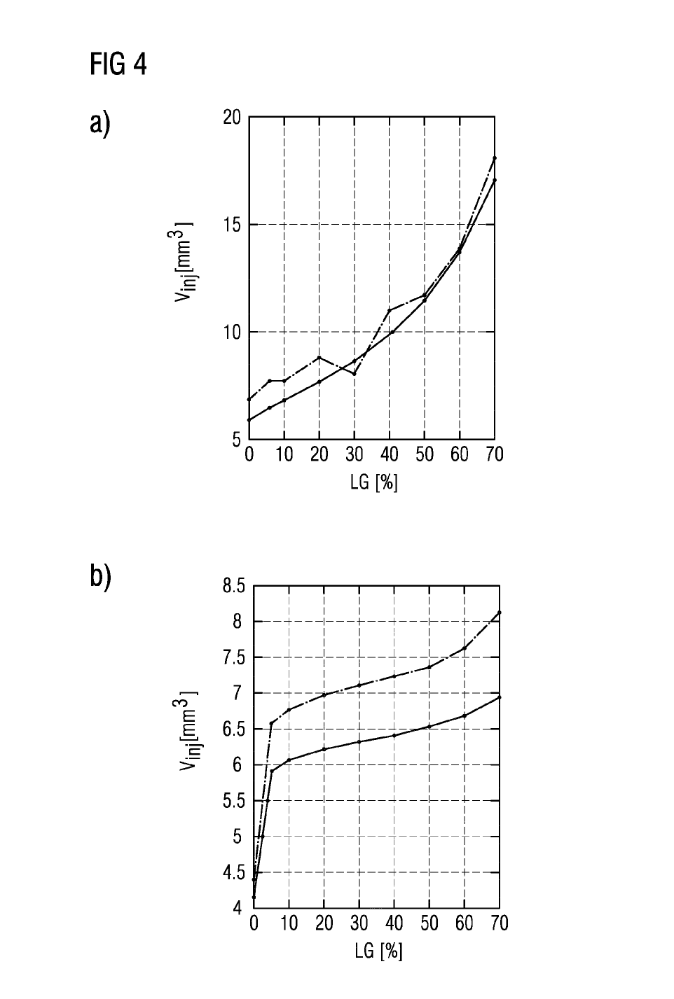

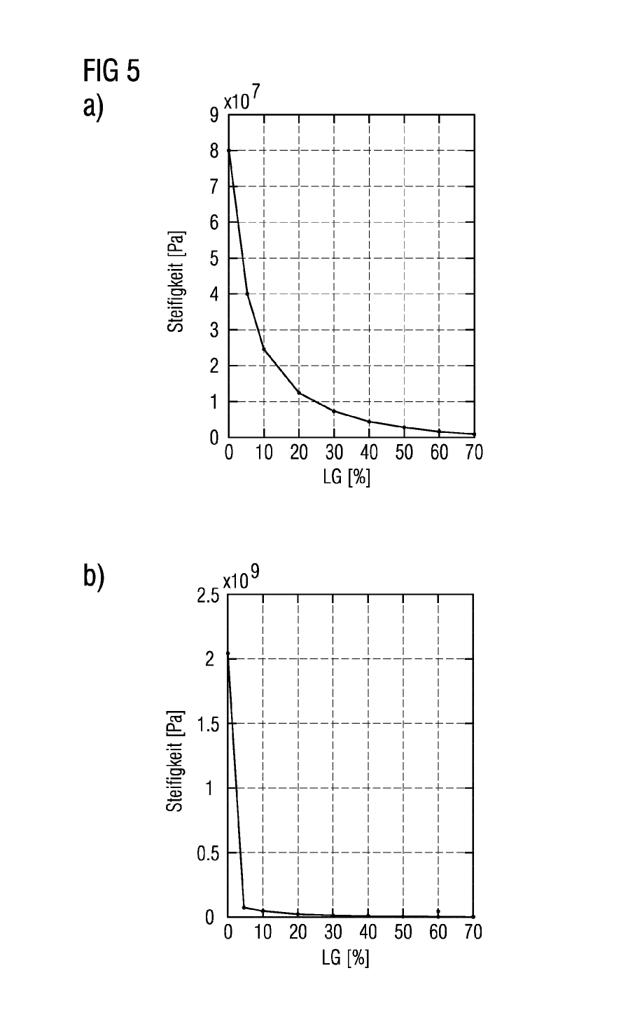

The following FIGS. 4 and 5 illustrate the different properties of flexible lines in comparison with the properties of rigid lines during an injection process, in each case as a function of the air content LG of the system. A flexible line is understood to be a line whose rigidity is comparatively low. A rigid line is understood to be a line whose rigidity is high, for example a steel line.

FIG. 4 shows diagrams illustrating the determined injected fuel volume Vᵢₙⱼ when a flexible line is present and when a steel line is present, in a method according to the invention and during a simulation. In this context, the determined injected volume when a flexible line is present is illustrated in FIG. 4a, and the injected volume when a steel line is present is illustrated in FIG. 4b, wherein the air content LG in the fluid is plotted in each case on the right. The continuous line shows here respectively the values determined for the injected fluid volume by means of a simulation, and the dot-dash line shows the values determined by means of a method according to the invention.

From the profiles illustrated in FIG. 4, it is apparent, in particular, that
the determined injected fluid volumes are different from one another,
the determined injected fluid volumes have the same profile, but are offset with respect one another, when a steel line is present.
the determined injected fluid volumes have different profiles when a flexible line is present, wherein when a simulation is carried out with an increasing air content LG the profile rises upward essentially exponentially, and when a method according invention is used it also rises upward essentially exponentially but has pronounced jumps.

FIG. 5 shows diagrams illustrating the rigidity as a function of the proportion of air in the fluid when a flexible line is present (FIG. 5a) and when a steel line is present (FIG. 5b). From these diagrams it is also apparent that the influences of the air content on the rigidity of the line system when a flexible line system is present is different than when a rigid line system is present, with the result that the injected fluid volumes differ from one another.

### LIST OF REFERENCE SYMBOLS

1 Line
2 Feed pump
3 Injection valve
4 Control unit
S1 Pressure sensor
S2 Pressure sensor
s1 Control signal
s2 Control signal
p1 Sensor signal, pressure value
p2 Sensor signal, pressure value

What is claimed is:

1. A method for controlling an injection process carried out by means of an injection system of a motor vehicle, in which a fluid is conveyed to an injection element through a line system, the method comprising:
determining a time of occurrence of a maximum pressure gradient caused by the injection process, based at least in part on output signals of a first pressure sensor;
calculating a difference between the time of occurrence of the maximum pressure gradient and a start time of the injection process;
determining a propagation speed of the fluid in the line system based at least in part on the difference;
determining a rigidity of the line system based at least in part on the propagation speed;
determining an injected volume the fluid based at least in part on the determined rigidity of the line system; and
controlling the injection process based on the injected volume determined.

2. The method as claimed in claim 1, wherein the start time is predefined by a control unit.

3. The method as claimed in claim 1, wherein the start time is determined based on the output signals of a second pressure sensor.

4. The method as claimed in claim 1, further comprising calculating an injected mass based at least in part on the injected fluid volume wand a density of the fluid.

5. The method as claimed in claim 1, wherein determining the propagation speed of the fluid in the line system includes calculating:
c=l/Δt,
wherein c is the propagation speed, l is a length of the line system, and Δt is the time difference between the time of the start of the injection process and the time of occurrence of the maximum of the pressure gradient caused by the injection process.

6. The method as claimed in claim 1, further comprising calculating a natural frequency of the line system based at least in part on the propagation speed and a length of the line system.

7. The method as claimed in claim 1, wherein determining the rigidity of the line system is based at least in part on the propagation speed and the density of the fluid.

8. The method as claimed in claim 7, further comprising retrieving the density of the fluid from a memory.

9. The method as claimed in claim 1, further comprising determining a pressure difference resulting from the injection process.

10. The method as claimed in claim 9, wherein the injected volume of the fluid is determined according to the following relationship:
Vᵢₙⱼ=(Vₜₒₜₐₗ·Δp)/E_{system},
wherein Vₜₒₜₐₗ is the total volume of the line system.

11. A device for controlling an injection process in an injection system of a motor vehicle, in which the fluid is conveyed to an injection element through a line system, the device comprising:
a control unit with a processor and a memory;
wherein the memory stores a set of instructions executable by the processor to:
determine a time of occurrence of a maximum pressure gradient caused by the injection process, based at least in paert on output signals of a first pressure sensor;
calculate a difference between the time of occurrence of the maximum pressure gradient and a start time of the injection process;
determine a propagation speed of the fluid in the line system based at least in part on the difference;
determine a rigidity of the line system based at least in part on the propagation speed;
determine an injected volume of the fluid based at least in part on the determined rigidity of the line system; and
control the injection process based on the injected volume determined.
